(19) United States
(12) Patent Application Publication
(10) Pub. No.: US 2004/0267880 A1
(43) Pub. Date: Dec. 30, 2004

(54) System and method for delivery of media content

(76) Inventor: Kestutis Patiejunas, Sammamish, WA (US)

Correspondence Address: SHOOK, HARDY & BACON L.L.P., 2555 GRAND BOULEVARD, KANSAS CITY, MO, 64108-2613, US

(21) Appl. No.: 10/608,637

(22) Filed: Jun. 30, 2003

(51) Int. Cl. G06F 15/16

(52) U.S. Cl. 709/203

(57) ABSTRACT

A video collection engine interfaces to one or more content providers, such as movie production or rental companies, downloadable audio outlets, software or software update sources, or other providers. The collection engine initiates a content transfer from one or more content providers on a periodic, demand-based or other basis to a local content store. The local content store may be cohosted in a DSLAM, cable headend or other local networking or communications facility and is generated and managed by the collection engine. Subscribers or recipients wishing to view a selected movie or other media product may program a computer, digital video recorder or other viewing or playback device to download the content from the local content store at network edge. Because downloads need not be performed directly from the remote content providers, whose content may require transport over Internet backbone or other links incurring a per-megabyte or other metered cost, video and other consumers may enjoy better efficiency, lower cost and potentially more reliable access to digital content.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of communications, and more particularly to a platform configured to retrieve, cache and deliver video, software and other media content from a local collection point.

### BACKGROUND OF THE INVENTION

The migration of video and other media content to digital formats has opened up new possibilities for the storage and delivery of movies, songs, software and other entertainment and productivity products. The advent of standard codecs such as Microsoft Windows AVI, Motion Pictures Experts Group (MPEG)-2, MPEG-4, Real Video™ and other standards or formats has permitted the efficient and relatively efficient distribution of that type of content. Distribution of movies, for instance, can now be done in a more compact format such as DVD discs, which permit more inexpensive shipping, storage and display of movies and other content.

Digitally encoded video combined with broadband access has likewise enabled the direct transmission of commercial movies or other content from a content provider to an end viewer over the Internet. As generally illustrated in FIG. 1, various commercial services allow a viewer to select one or more movies to watch, program the downloading of that content and view the content once received. Such delivery services are not, however, as cost efficient as might be possible.

For instance, with certain of the services providing access to video content, the transmission of that content (shown as CONTENT 1 . . . CONTENT N) is reinitiated with the receipt of every new request (shown as REQ 1 . . . REQ N) from a consumer to download and view that movie or other product. That transmission may traverse various communications links from the server of the content provider, over a backbone or other comparatively high-speed Internet connection, to a local access point such as a digital subscriber line access multiplexer (DSLAM) or cable head end, and finally to the consumer. In most network arrangements, following this transmission path incurs a per-megabyte cost to traverse the backbone link, a cost that is passed on to the consumer in subscription rates or other fees. Other problems exist.

### SUMMARY OF THE INVENTION

The invention overcoming these and other problems in the art relates in one regard to a system and method for demand-based delivery of media content, which in one regard deploy a collection engine between a content provider and end viewers of video or other content. In embodiments, the collection engine may be cohosted in a DSLAM, cable head end, or other local communications facility from which the subscriber receives Internet or other network access. The collection engine may initiate the loading of video, audio, software or other media from remote content providers into an associated local content store, on a predetermined schedule or based on demand or other criteria. Subscribers wishing to view one or more parts of the currently stored video, audio, software or other content may in turn request a download of their selections from that content store to a computer or other viewing or playback device. That download may occur during offpeak or other times. Once downloaded, in embodiments the subscriber may gain authorization to view the content via a key or other authentication mechanism. According to the invention in one regard, because the storage of the digital content has effectively been shifted to a collection point which is local to subscribers, content may be delivered to each individual subscriber for their separate views, without incurring additional per-megabyte or other backbone or other metered network charges.

### BRIEF DESCRIPTION OF THE DRAWINGS

FIG. 1 illustrates a video distribution network, according to a conventional embodiment.

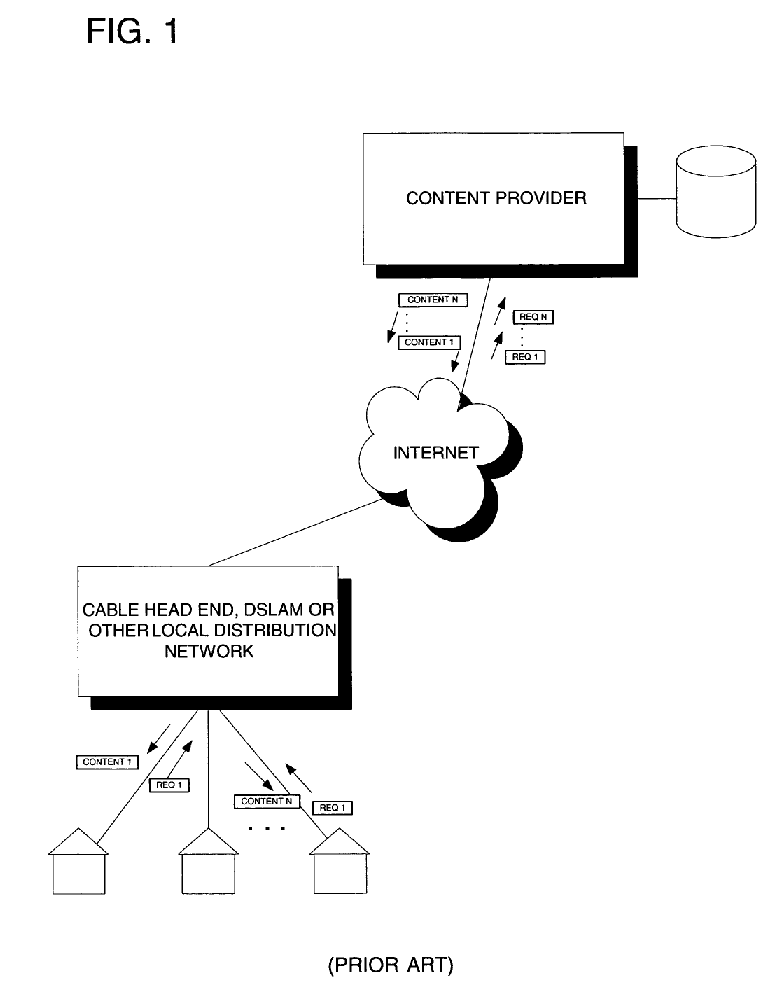

FIG. 2 illustrates an architecture for distribution of media or other content, according to an embodiment of the invention.

FIG. 3 illustrates a user interface operable by a subscriber or others, to activate downloading of content, according to an embodiment of the invention.

FIG. 4 illustrates a flowchart of content download processing, according to an embodiment of the invention.

FIG. 5 illustrates a n architecture for distribution of media or other content, according to an embodiment of the invention.

### DETAILED DESCRIPTION OF EMBODIMENTS

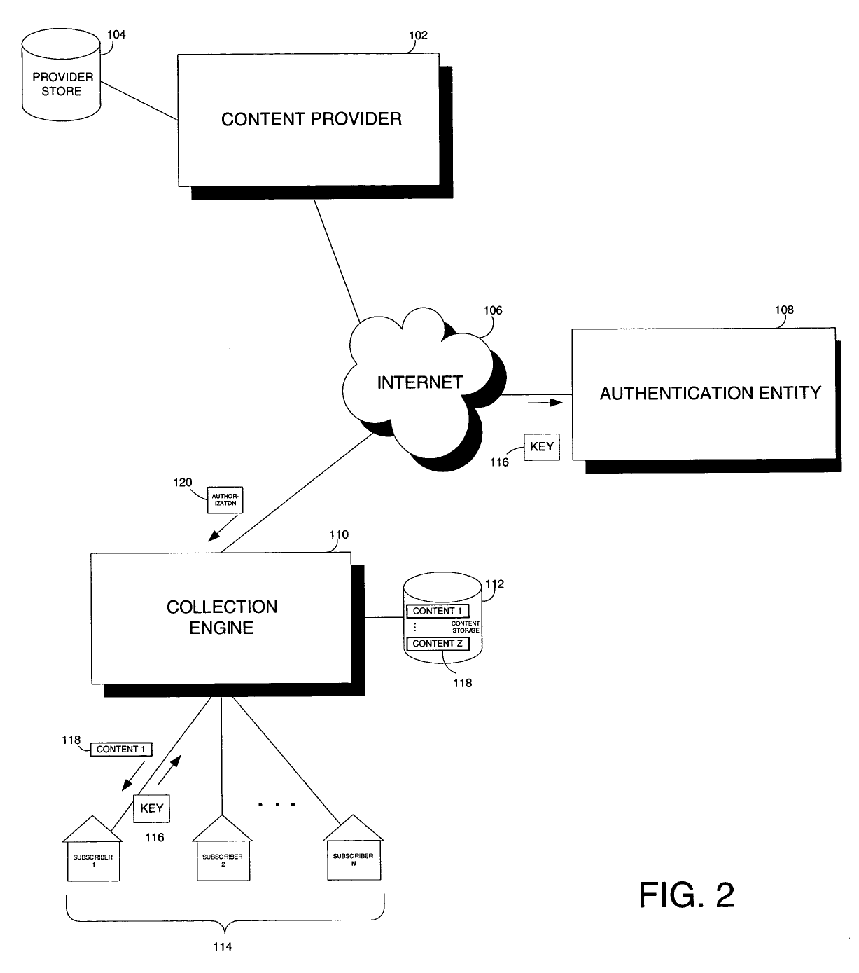

FIG. 2 illustrates an architecture in which a system and method for delivery of media content may operate, according to an embodiment of the invention. As illustrated in that figure, a content provider 102 may generate or host content 118 stored in provider storage 104, which may for instance be or include a database or other storage. Content 118 in embodiments may be or include any one or more of digital video for instance in Windows™ AVI, Real Video, MPEG-2 or MPEG-4 or other formats, digital audio for instance in .WAV, MP3 or other formats, digital graphics for instance in .JPG, .BMP or other formats, computer software such as executable program files, patches, updates, transmittable applets such as ones in Java™ or other code, or other data, media or content.

Content provider 102 may make content 118 accessible via communications network 106. Communications network 106 may be, include or interface to any one or more of, for instance, the Internet, an intranet, a local area network (LAN), a wide area network (WAN), a metropolitan area network (MAN), a storage area network (SAN), a frame relay connection, an Advanced Intelligent Network (AIN) connection, a synchronous optical network (SONET) connection, a digital T1, T3, E1 or E3 line, Digital Data Service (DDS) connection, an ATM (Asynchronous Transfer Mode) connection, an FDDI (Fiber Distributed Data Interface), CDDI (Copper Distributed Data Interface) or other wired, wireless or optical connection. In embodiments, communications network 106 may include a comparatively high-capacity backbone link, such as a fiber optic or other link, connecting to content provider 102, for transmission over which a carrier or other entity impose a per-megabyte or other metered or tariffed cost.

Content provider 102 may be linked via communications network 106 to a collection engine 110. Collection engine 110 itself in turn may be generally be connected via a local communications network 126 to a subscriber group 114 (illustrated as subscriber 1, subscriber 2, . . . subscriber n, n arbitrary). In embodiments, the collection engine 110 may be, include or interface to, for example, a DSLAM, a cable modem head end, a telephone central office, a wireless access point such as a cellular base station, or other communications hub or facility. Local communications network 126 may in embodiments correspondingly be, include or interface to, for example, a digital subscriber line, a cable modem connection, a telephone line, an ISDN connection, a GSM or other data-enabled wireless link, or other links or resources. Collection engine 110 may likewise communicate with an associated content storage 112, which may in embodiments be, include or interface to a database which may be supported by server or other resources, and may in embodiments include redundancy or failover capability, such as a redundant array of independent disks (RAID), for data protection.

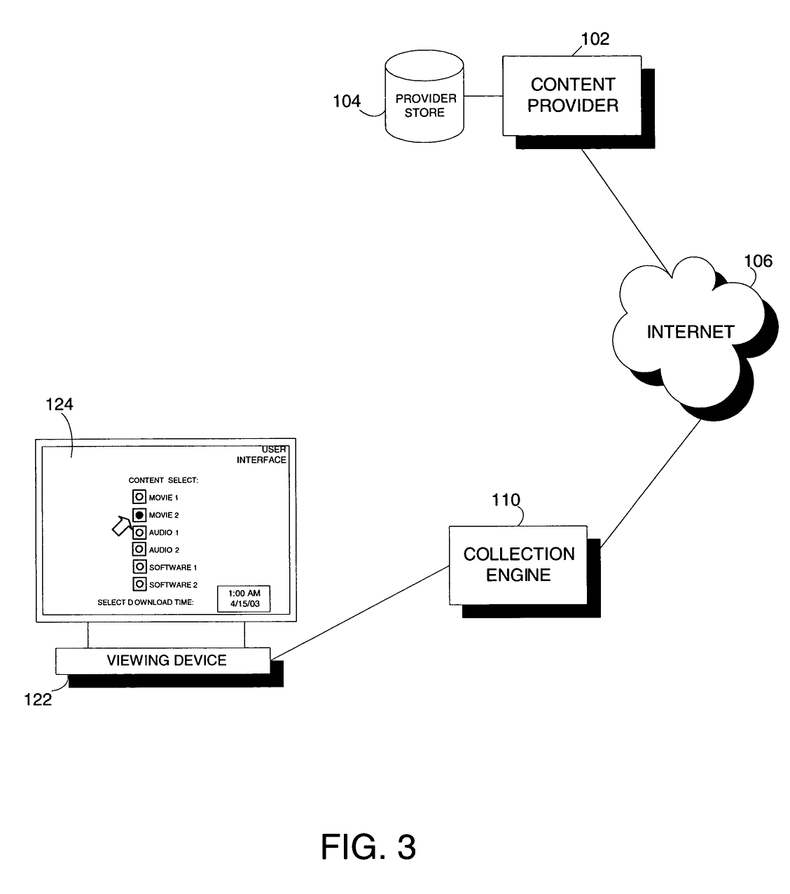

According to an embodiment of the invention in one regard, one or more individual subscribers within subscriber group 114 may initiate a request to download and view, execute or activate one or more individual pieces of content 118 to collection engine 110. For instance, subscribers within subscriber group 114 may select a video, audio, graphical, software or other product for downloading. As illustrated in FIG. 3, in embodiments subscribers within subscriber group 114 may operate a viewing device 122, such as a computer, a digital video device or other playback or viewing device to select and view the desired content 118. As also illustrated in that figure, subscribers within subscriber group 114 may in embodiments manipulate a user interface 124, such as a graphical user interface, a voice command, command line or other user interface to view available content 118 and select desired content, such as digital video movies or other services or products. Viewing device 122 may likewise be or include, for instance, a programmable video recording device, such as hard drive, recordable optical drive or other drive-based machines.

The content 118 made available to subscribers within subscriber group 114 from the content storage 112 of collection engine 110 may change over time, for instance to refresh a catalogue of videos, music, software or other media or content, for instance on a daily, weekly, monthly or other scheduled or unscheduled basis. For instance, in embodiments the set of content 118 presented to subscribers within subscriber group 114 may be dynamically allocated, depending on the total number of requests for a piece of content made by subscribers, license or other fees applied by content provider 102, or based on other factors. The content 118 stored in content storage 112 of collection engine 110 may in embodiments reflect all content available from content provider 102, or subsets or other portions of that or other content.

When one or more of the subscribers within subscriber group 114 initiates a request to download content 118 to collection engine 110, the collection engine 110 may, after verifying the availability of that content, query that subscriber or subscribers for a key 116. The key 116 may be or include a digital certificate, a public key infrastructure (PKI) or other object authenticating subscribers within the subscriber group 114 and their right to access content 118, for instance via an authentication entity 108 communicating with collection engine 110 via communications network 106. Authentication entity 108 may decrypt or otherwise process key 116 to authenticate subscribers within subscriber group 114 and their right to access content 118. If an invalid or expired key 116 is received, authentication entity 108 may reject the request for authentication to collection engine 110, which in turn may terminate downloading or access activity.

In embodiments, the validity of a request for download by subscribers within subscriber group 114 may depend or depend in part on the current validity of an account held by individual subscribers, the account being with an operator of collection engine 110, with content provider 102, or with other entities. In embodiments subscribers within subscriber group 114 may pay a regular monthly or other subscription or license fee to access content 118. In other embodiments, subscribers within subscriber group 114 may download or access content 118 on a pay-per-view or pay-per-use or other nonrecurring basis. Other subscription, non-subscription or other access arrangements are possible.

When the request by one or more subscribers in subscriber group 114 is authenticated, authentication entity 108 may transmit an authorization 120 to collection engine 110. Collection engine 110 may consequently configure a download or other access of content 118 by the requesting subscriber or subscribers within subscriber group 114. In embodiments, the download of content 118 may be initiated immediately via local communications network 126. In other embodiments, collection engine 110 may schedule the content 118 for download at a later or predetermined time, for instance late at night, when the local communications network 126 is comparatively idle, or at other times. In embodiments, the download of content 118 may be performed in batch mode, transferring portions of content 118 at a time, rather than continuously.

Depending on implementation, once the transfer of content 118 to the viewing device 122 or other playback or viewing device is complete, the requesting subscriber or subscribers within subscriber group 114 may immediately view, listen to, execute or otherwise make use of content 118, or may likewise use key 116 or another security mechanism to unlock and access content 118 from memory, associated hard drive or other storage. The receiving subscriber or subscribers within subscriber group 114 may, for instance, view a digital video or movie, view graphics, listen to digitally encoded music, install, execute, update or operate software, or use content 118 in other ways. The content 118 may, once delivered and activated, be subject to a timing mechanism to cause the content 118 to expire after a predetermined amount of time or number of uses, or expire based on other conditions. In embodiments, the content 118 may be subject to digital rights management (DRM) or other controls to prevent unauthorized reproduction, use, or other manipulation of content 118.

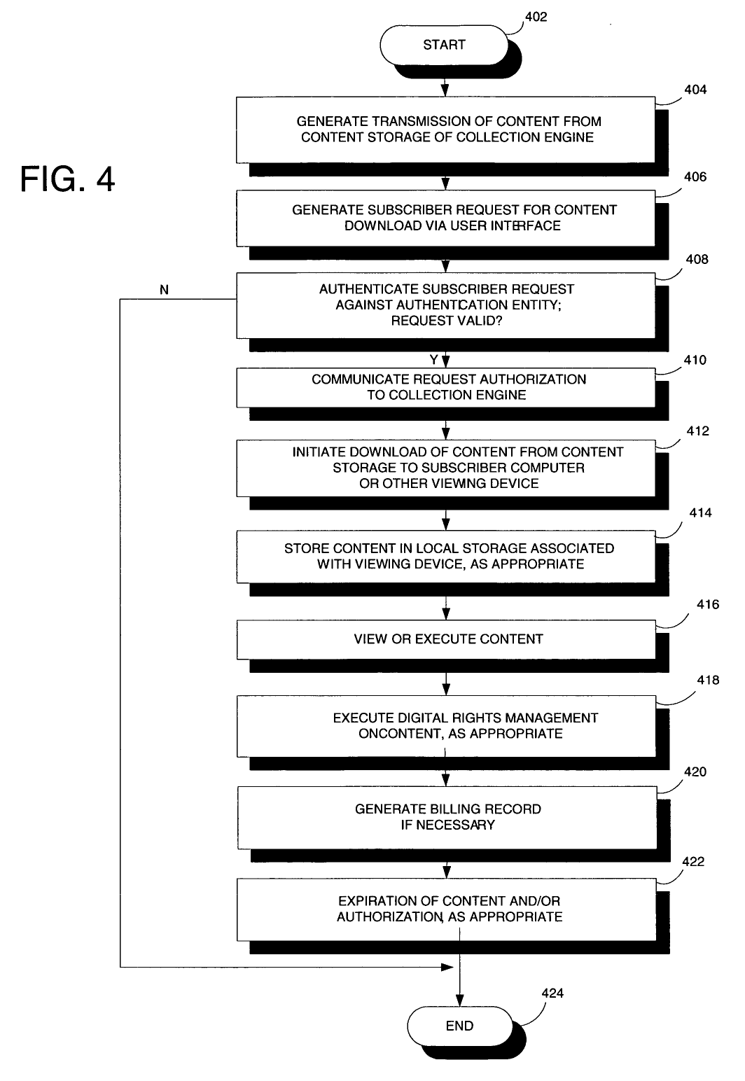

FIG. 4 illustrates a flowchart of content delivery processing, according to an embodiment of the invention. In step 402, processing begins. In step 404, a transmission of content 118 from content provider 102 to collection engine 110 for storage in content storage 112 may be generated, for instance on a predetermined schedule, on a demand basis such as reaching a minimum number of subscriber requests for the content, or at other times or under other conditions. In step 406, a subscriber may generate a request for a download of content 118 via user interface 124 of viewing device 122 or other viewing or playback device.

In step 408, the request for a download of content 118 by one or more subscriber within subscriber group 114 may be authenticated or validated against the authentication entity 108. If the request is authenticated to be valid, processing may proceed to step 410 in which an authorization 120 may be communicated to the collection engine 110. In step 412, a download of content 118 from content storage 112 to the viewing device 124 or other viewing or playback device of the requesting subscriber or subscribers within subscriber group 114 may be initiated. In step 414, content 118 may be stored in local storage associated with the viewing device 124, such as a hard drive or recordable optical disc, or other storage.

In step 416, the content 118 may be viewed, as in the case of digital video, executed, in the case of software content, listened to, in the case of audio content, or otherwise accessed or executed. In step 418, digital rights management or other copy or other control may be executed on content 118, for instance to prevent unauthorized copies from being made. In step 420, a billing record for the download and use of content 118 may be generated, as appropriate. In embodiments, a per-view or per-download charge may appear on a cable television or cable Internet account, or charges or fees may accrue or be presented in other ways. In step 422, a predetermined, conditioned or other expiration of content 118 or of authorization 120 may occur. This expiration may for instance cause video, audio or other content to expire after a certain period, number of views or listens, or when other conditions are met. In step 424, processing may end, repeat, return to other processing steps or take other action.

In step 408, if the subscriber or other recipient request is not authenticated against authentication entity 108, processing may proceed to step 424 to likewise end, repeat, return to other processing steps or take other action.

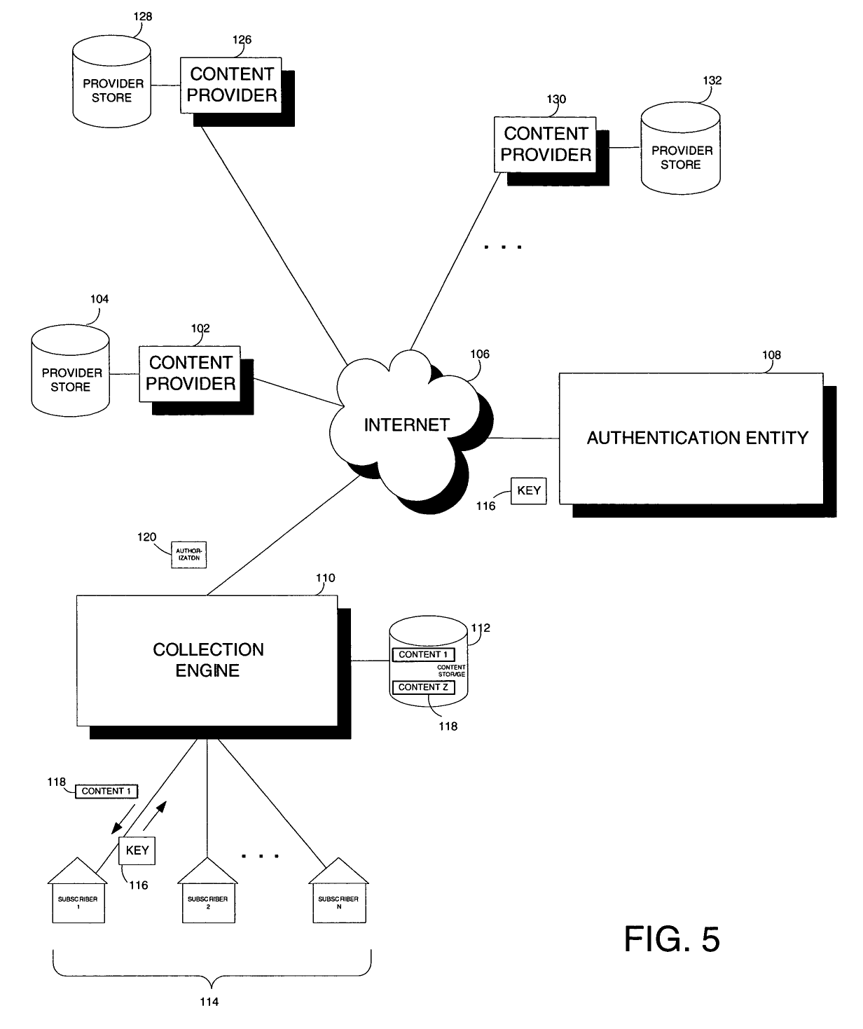

FIG. 5 illustrates an architecture in which an embodiment of the invention may operate, also including a collection engine 110 such as a DSLAM, cable head end, wireless access point or other communications or distribution platform. In the embodiment shown in that figure, the collection engine 110 may interface to and receive content 118 from multiple content providers, illustrated as content provider 102, content provider 126 and content provider 128. Although a total of three content providers are illustrated, any number may be accessed. Each of the content providers may have associated with it provider storage, illustrated as provider storage 104, provider storage 128, provider storage 132, but any number of separate or shared storage media or facilities may be incorporated or used.

In the embodiment illustrated in FIG. 5, subscribers within subscriber group 114 may request content 118 from any one or more of content provider 102, content provider 126 and content provider 128 or from other sources, for download via collection engine 110. In embodiments, billing records may be generated by collection 110 to be returned to a given one or more of the content providers, depending on download activity and subscription and pay-per-view or other arrangements. In this embodiment, subscribers in subscriber group 114 may consequently preview, select and download content from a variety of video, audio, software or other sources, from a unified collection in content storage 112 or other media.

The foregoing description of the invention is illustrative, and modifications in configuration and implementation will occur to persons skilled in the art. For instance, while the invention has generally been described in terms of one or more subscribers viewing video or listening to audio content via a cable modem, DSL or other wired communications link, as noted in embodiments the client or viewing device may communicate with the collection engine 110 via wireless interfaces, such as GSM, 802.11× or other protocols.

Similarly, while the invention has in embodiments been described as carrying out download authentication via a remote authentication entity 108, in embodiments the collection engine 110 or other resources in the network may perform an authentication function. Multiple authentication databases may be used. Other hardware, software or other resources described as singular may in embodiments be distributed, and similarly in embodiments resources described as distributed may be combined. Yet further, while the invention has generally been described in terms of one or more subscribers in subscriber group 114 receiving content 118, in embodiments subscribers in subscriber group 114 may upload content or other data to collection engine or other destinations. The scope of the invention is accordingly intended to be limited only by the following claims.

We claim:

1. A system for managing the transmission of distributable content, comprising:
a collection engine, the collection engine configured to receive distributable content from at least one content provider via a first network;
content storage, the content storage communicating with the collection engine to store the distributable content; and
an interface to a second network communicating with a subscriber, the subscriber selectively receiving the distributable content from the collection storage via the second network.

2. A system according to claim 1, wherein the first network comprises a communication link via the Internet.

3. A system according to claim 2, wherein the communication link comprises a backbone link.

4. A system according to claim 1, wherein the collection engine comprises a digital subscriber line access multiplexer.

5. A system according to claim 4, wherein the second network comprises a digital subscriber line connection.

6. A system according to claim 1, wherein the collection engine comprises a cable head end.

7. A system according to claim 6, wherein the second network comprises a cable modem connection.

8. A system according to claim 1, wherein the collection engine comprises a wireless interface.

9. A system according to claim 8, wherein the second network comprises at least one of an 802.11a, an 802.11b, and an 802.11g interface.

10. A system according to claim 1, wherein the collection engine comprises a central telephone office.

11. A system according to claim 10, wherein the second network comprises a dial up modem connection.

12. A system according to claim 1, wherein the collection engine comprises an optical head end.

13. A system according to claim 12, wherein the second network comprises a fiber optic connection.

14. A system according to claim 1, wherein the collection engine comprises a server.

15. A system according to claim 14, wherein the second network comprises at least one of a local area network, a wide area network, and a metropolitan area network.

16. A system according to claim 1, wherein the content storage comprises a database.

17. A system according to claim 1, wherein the subscriber selectively receives the distributable content at scheduled times.

18. A system according to claim 1, wherein the subscriber selectively receives the distributable content at a viewing device.

19. A system according to claim 18, wherein the viewing device comprises at least one of a computer, a television, and a programmable video recording device.

20. A system according to claim 18, wherein the viewing device comprises local storage.

21. A system according to claim 20, wherein the distributable content is stored in the local storage.

22. A system according to claim 21, wherein the distributable content stored in the local storage is configured to expire after a predetermined time.

23. A system according to claim 21, wherein reproduction of the distributable content stored in the local storage is selectively controlled.

24. A system according to claim 23, wherein the selective control of the reproduction of the distributable content stored in the local storage comprises digital rights management.

25. A system according to claim 18, wherein the subscriber activates the viewing of the distributable content at the viewing device via a key mechanism.

26. A system according to claim 25, wherein the key mechanism comprises authentication via the fist network.

27. A system according to claim 1, wherein the distributable content comprises digitally encoded content.

28. A system according to claim 27, wherein the digitally encoded content comprises at least one of digitally encoded video, digitally encoded graphics, digitally encoded audio, and computer software.

29. A system according to claim 1, wherein the subscriber subscribes to the at least one content provider.

30. A system according to claim 1, wherein the subscriber selectively receives the distributable content on a pay-per-use basis.

31. A system according to claim 1, wherein the at least one content provider comprises more than one content provider.

32. A system according to claim 1, wherein the collection engine receives the distributable content from the at least one content provider based on a predetermined schedule.

33. A system according to claim 1, wherein the collection engine receives the distributable content from the at least one content provider on a usage demand basis.

34. A method for managing the transmission of distributable content, comprising:
receiving distributable content from at least one content provider via a first network;
storing the distributable content in content storage; and
selectively communicating the distributable content from the content storage to a subscriber via a second network.

35. A method according to claim 34, wherein the first network comprises a communication link via the Internet.

36. A method according to claim 35, wherein the communication link comprises a backbone link.

37. A method according to claim 34, wherein the step of receiving the distributable content comprises a step of receiving the distributable content in a digital subscriber line access multiplexer.

38. A method according to claim 37, wherein the second network comprises a digital subscriber line connection.

39. A method according to claim 38, wherein the step of receiving the distributable content comprises a step of receiving the distributable content in a cable head end.

40. A method according to claim 39, wherein the second network comprises a cable modem connection.

41. A method according to claim 34, wherein the step of receiving the distributable content comprises a step of receiving the distributable content in a wireless interface station.

42. A method according to claim 41, wherein the second network comprises at least one of an 802.11a, an 802.11b, and an 802.11g interface.

43. A method according to claim 34, wherein the step of receiving the distributable content comprises a step of receiving the distributable content in a central telephone office.

44. A method according to claim 43, wherein the second network comprises a dial up modem connection.

45. A method according to claim 34, wherein the step of receiving the distributable content comprises a step of receiving the distributable content in an optical head end.

46. A method according to claim 45, wherein the second network comprises a fiber optic connection.

47. A method according to claim 34, wherein the step of receiving the distributable content comprises a step of receiving the distributable content in a server.

48. A method according to claim 45, wherein the second network comprises at least one of a local area network, a wide area network, and a metropolitan area network.

49. A method according to claim 34, wherein the content storage comprises a database.

50. A method according to claim 34, wherein the step of selectively communicating comprises a step of receiving the distributable content at scheduled times.

51. A method according to claim 34, wherein the step of selectively communicating comprises a step of receiving the distributable content at a viewing device.

52. A method according to claim 51, wherein the viewing device comprises at least one of a computer, a television, and a programmable video recording device.

53. A method according to claim 51, wherein the viewing device comprises local storage.

54. A method according to claim 53, further comprising a step of storing the distributable content on the local storage.

55. A method according to claim 54, wherein the distributable content stored in the local storage is configured to expire after a predetermined time.

56. A method according to claim 54, further comprising a step of selectively controlling reproduction of the distributable content stored in the local storage.

57. A method according to claim 56, wherein the step of selectively controlling the reproduction of the distributable content comprises a step of executing a digital rights management module.

58. A method according to claim 51, further comprising a step of activating the viewing of the distributable content at the viewing device via a key mechanism.

59. A method according to claim 58, wherein the key mechanism comprises authentication via the fist network.

60. A method according to claim 34, wherein the distributable content comprises digitally encoded content.

61. A method according to claim 60, wherein the digitally encoded content comprises at least one of digitally encoded video, digitally encoded graphics, digitally encoded audio, and computer software.

62. A method according to claim 34, wherein the subscriber of the distributable content subscribes to the at least one content provider.

63. A method according to claim 34, wherein the subscriber of the distributable content selectively receives the distributable content on a pay-per-use basis.

64. A method according to claim 34, wherein the at least one content provider comprises more than one content provider.

65. A method according to claim 34, wherein the step of receiving the distributable content from the at least one content provider comprises a step of receiving the distributable content from the at least one content provider based on a predetermined schedule.

66. A method according to claim 34, wherein the step of receiving the distributable content from the at least one content provider comprises a step of receiving the distributable content from the at least one content provider on a usage demand basis.

67. A system for managing the transmission of distributable content, comprising:
content collection means for receiving distributable content from at least one content provider via first network means;
content storage means, communicating with the content collection means, for storing the distributable content; and
interface means for communicating with second network means communicating with a subscriber, the subscriber selectively receiving the distributable content from the content storage means via the second network means.

68. A system according to claim 67, wherein the first network means comprises a communication link via the Internet.

69. A system according to claim 68, wherein the communication link comprises a backbone link.

70. A system according to claim 67, wherein the content collection means comprises at least one of digital subscriber line access multiplexer means, cable head end means, wireless interface means, central telephone office means, and server means.

71. A system according to claim 67, wherein the content storage means comprises database means.

72. A system according to claim 67, wherein the subscriber selectively receives the distributable content at scheduled times.

73. A system according to claim 67, wherein the subscriber selectively receives the distributable content at viewing means.

74. A system according to claim 73, wherein the viewing means comprises at least one of computer means, television means, and programmable video recording means.

75. A system according to claim 74, wherein the viewing means comprises local storage means.

76. A system according to claim 75, wherein the distributable content is stored in the local storage means.

77. A system according to claim 67, wherein the subscriber activates the viewing of the distributable content at the viewing means via a key mechanism.

78. A system according to claim 67, wherein the distributable content comprises digitally encoded content.

79. A system according to claim 78, wherein the digitally encoded content comprises at least one of digitally encoded video, digitally encoded graphics, digitally encoded audio, and computer software.

80. A computer readable medium, the computer readable medium being readable by a computer to execute a method of managing the transmission of distributable content, the method comprising:
receiving distributable content from at least one content provider via a first network;
storing the distributable content in content storage; and
selectively communicating the distributable content from the content storage to a subscriber via a second network.

81. A computer readable medium according to claim 80, wherein the first network comprises a communication link via the Internet.

82. A computer readable medium according to claim 81, wherein the communication link comprises a backbone link.

83. A computer readable medium according to claim 80, wherein the step of receiving the distributable content comprises a step of receiving the distributable content in at least one of a digital subscriber line access multiplexer, a cable head end, a wireless interface, a central telephone office, and a server.

84. A computer readable medium according to claim 80, wherein the content storage comprises a database.

85. A computer readable medium according to claim 80, wherein the step of selectively communicating comprises a step of selectively receiving the distributable content at scheduled times.

86. A computer readable medium according to claim 80, wherein the step of selectively communicating comprises a step of selectively receiving the distributable content at a viewing device.

87. A computer readable medium according to claim 86, wherein the viewing device comprises at least one of a computer, a television, and a programmable video recording device.

88. A computer readable medium according to claim 86, wherein the viewing device comprises local storage.

89. A computer readable medium according to claim 88, wherein the method further comprises a step of storing the distributable content in the local storage.

90. A computer readable medium according to claim 86, wherein the method further comprises a step of activating the viewing of the distributable content at the viewing device via a key mechanism.

91. A computer readable medium according to claim 80, wherein the distributable content comprises digitally encoded content.

92. A computer readable medium according to claim 91, wherein the digitally encoded content comprises at least one of digitally encoded video, digitally encoded graphics, digitally encoded audio, and computer software.

93. A system for receiving a transmission of distributable content, comprising:
an interface to a network communicating with content storage, the content storage storing distributable content received from at least one content provider for transmission to a subscriber;
a user interface, the user interface configured to permit the subscriber to selectively receive the distributable content; and
an interface to a viewing device for viewing the distributable content.

94. A system according to claim 93, wherein the interface to the network comprises at least one of a digital subscriber line access multiplexer, a cable head end, a wireless interface, a central telephone office, a local area network, a wide area network, and a metropolitan area network.

95. A system according to claim 93, wherein the user interface is configured to permit the subscriber to selectively receive the distributable content at selected times.

96. A system according to claim 93, wherein the user interface is configured to permit the subscriber to selectively receive the distributable content as a background task.

97. A system according to claim 93, wherein the user interface comprises a viewing authorization module.

98. A system according to claim 97, wherein the viewing authorization module comprises a key authorization mechanism.

99. A system according to claim 93, wherein the viewing device comprises local storage to store the distributable content.

100. A system according to claim 99, wherein reproduction of the distributable content stored in the local storage is selectively controlled.

101. A system according to claim 100, wherein the selective control of the reproduction of the distributable content stored in the local storage comprises digital rights management.

102. A system according to claim 93, wherein the subscriber subscribes to the at least one content provider.

103. A system according to claim 93, wherein the subscriber selectively receives the distributable content on a pay-per-use basis.

104. A system according to claim 93, wherein the distributable content comprises digitally encoded content.

105. A system according to claim 104, wherein the digitally encoded content comprises at least one of digitally encoded video, digitally encoded graphics, digitally encoded audio, and computer software.

106. A system according to claim 93, wherein the viewing device comprises at least one of a computer, a television, and a programmable video recording device.

107. A method for managing the receipt of distributable content, comprising:
connecting to a network communicating with content storage, the content storage storing distributable content received from at least one content provider for transmission to a subscriber;
presenting a user interface to permit the subscriber to selectively receive the distributable content; and
generating an output of the distributable content to view on a viewing device.

108. A method according to claim 107, wherein the step of connecting to a network comprises connecting to at least one of a digital subscriber line access multiplexer, a cable head end, a wireless interface, a central telephone office, a local area network, a wide area network, and a metropolitan area network.

109. A method according to claim 107, wherein the step of presenting a user interface comprises a step of presenting selectable options to permit the subscriber to receive the distributable content at selected times.

110. A method according to claim 107, wherein the step of presenting a user interface comprises a step of presenting selectable options to permit the subscriber to selectively receive the distributable content as a background task.

111. A method according to claim 107, wherein the step of presenting a user interface comprises a step of executing a viewing authorization module.

112. A method according to claim 111, wherein the step of executing a viewing authorization module comprises a step of executing a key authorization mechanism.

113. A method according to claim 107, wherein the viewing device comprises local storage to store the distributable content.

114. A method according to claim 113, further comprising a step of selectively controlling the reproduction of the distributable content stored in the local storage.

115. A method according to claim 14, wherein the step of selectively controlling the reproduction of the distributable content stored in the local storage comprises executing a digital rights management module.

116. A method according to claim 107, wherein the subscriber subscribes to the at least one content provider.

117. A method according to claim 107, wherein the subscriber selectively receives the distributable content on a pay-per-use basis.

118. A method according to claim 107, wherein the distributable content comprises digitally encoded content.

119. A method according to claim 118, wherein the digitally encoded content comprises at least one of digitally encoded video, digitally encoded graphics, digitally encoded audio, and computer software.

120. A method according to claim 107, wherein the viewing device comprises at least one of a computer, a television, and a programmable video recording device.

121. A system for receiving a transmission of distributable content, comprising:
first interface means for interfacing to a network communicating with content storage means, the content storage means for storing distributable content received from at least one content provider for transmission to a subscriber;
user interface means for permitting a subscriber to selectively receive the distributable content; and
second interface means for interfacing to viewing means for viewing the distributable content.

122. A system according to claim 121, wherein the first interface means comprises at least one of digital subscriber line access multiplexer means, cable head end means, wireless interface means, central telephone office means, local area network means, wide area network means, and metropolitan area network means.

123. A system according to claim 121, wherein the user interface means is configured to permit the subscriber to selectively receive the distributable content at selected times.

124. A system according to claim 121, wherein the user interface means is configured to permit the subscriber to selectively receive the distributable content as a background task.

125. A system according to claim 121, wherein the user interface means comprises viewing authorization means.

126. A system according to claim 125, wherein the viewing authorization means comprises a key authorization means.

127. A system according to claim 121, wherein the viewing means comprises local storage means to store the distributable content.

128. A system according to claim 127, wherein reproduction of the distributable content stored in the local storage means is selectively controlled.

129. A system according to claim 128, wherein the selective control of the reproduction of the distributable content stored in the local storage means comprises digital rights management.

130. A system according to claim 121, wherein the subscriber subscribes to the at least one content provider.

131. A system according to claim 121, wherein the subscriber selectively receives the distributable content on a pay-per-use basis.

132. A system according to claim 121, wherein the distributable content comprises digitally encoded content.

133. A system according to claim 132, wherein the digitally encoded content comprises at least one of digitally encoded video, digitally encoded graphics, digitally encoded audio, and computer software.

134. A system according to claim 121, wherein the viewing means comprises at least one of computer means, television means, and programmable video recording means.

135. A computer readable medium, the computer readable medium being readable by a computer to execute a method for managing the receipt of distributable content, the method comprising:
connecting to a network communicating with content storage, the content storage storing distributable content received from at least one content provider for transmission to a subscriber;
presenting a user interface to permit the subscriber to selectively receive the distributable content; and
generating an output of the distributable content to view on a viewing device.

136. A computer readable medium according to claim 135, wherein the step of connecting to a network comprises connecting to at least one of a digital subscriber line access multiplexer, a cable head end, a wireless interface, a central telephone office, a local area network, a wide area network, and a metropolitan area network.

137. A computer readable medium according to claim 135, wherein the step of presenting a user interface comprises a step of presenting selectable options to permit the subscriber to receive the distributable content at selected times.

138. A computer readable medium according to claim 135, wherein the step of presenting a user interface comprises a step of presenting selectable options to permit the subscriber to selectively receive the distributable content as a background task.

139. A computer readable medium according to claim 135, wherein the step of presenting a user interface comprises a step of executing a viewing authorization module.

140. A computer readable medium according to claim 139, wherein the step of executing a viewing authorization module comprises a step of executing a key authorization mechanism.

141. A computer readable medium according to claim 135, wherein the viewing device comprises local storage to store the distributable content.

142. A computer readable medium according to claim 141, wherein the method further comprises a step of selectively controlling the reproduction of the distributable content stored in the local storage.

143. A computer readable medium according to claim 142, wherein the step of selectively controlling the reproduction of the distributable content stored in the local storage comprises executing a digital rights management module.

144. A computer readable medium according to claim 135, wherein the subscriber subscribes to the at least one content provider.

145. A computer readable medium according to claim 135, wherein the subscriber selectively receives the distributable content on a pay-per-use basis.

146. A computer readable medium according to claim 135, wherein the distributable content comprises digitally encoded content.

147. A computer readable medium according to claim 146, wherein the digitally encoded content comprises at least one of digitally encoded video, digitally encoded graphics, digitally encoded audio, and computer software.

148. A computer readable medium according to claim 135, wherein the viewing device comprises at least one of a computer, a television, and a programmable video recording device.

149. A transmittable media object, the transmittable media object being generated according to a method of:
receiving distributable content from at least one content provider via a first network;
storing the distributable content in content storage; and
selectively communicating the distributable content from the content storage to a subscriber via a second network.

150. A transmittable media object generated according to claim 149, wherein the first network comprises a communication link via the Internet.

151. A transmittable media object generated according to claim 150, wherein the communication link comprises a backbone link.

152. A transmittable media object generated according to claim 149, wherein the step of receiving the distributable content comprises a step of receiving the distributable content in at least one of a digital subscriber line access multiplexer, a cable head end, a wireless interface, a central telephone office, and a server.

153. A transmittable media object generated according to claim 149, wherein the content storage comprises a database.

154. A transmittable media object generated according to claim 149, wherein the step of selectively communicating comprises a step of selectively receiving the distributable content at scheduled times.

155. A transmittable media object generated according to claim 149, wherein the step of selectively communicating comprises a step of selectively receiving the distributable content at a viewing device.

156. A transmittable media object generated according to claim 155, wherein the viewing device comprises at least one of a computer, a television, and a programmable video recording device.

157. A transmittable media object generated according to claim 155, wherein the viewing device comprises local storage.

158. A transmittable media object generated according to claim 157, wherein the method further comprises a step of storing the distributable content in the local storage.

159. A transmittable media object generated according to claim 149, wherein the method further comprises a step of activating the viewing of the distributable content at the viewing device via a key mechanism.

160. A transmittable media object generated according to claim 149, wherein the distributable content comprises digitally encoded content.

161. A transmittable media object generated according to claim 160, wherein the digitally encoded content comprises at least one of digitally encoded video, digitally encoded graphics, digitally encoded audio, and computer software.
